(19) United States
(12) Patent Application Publication
(10) Pub. No.: US 2024/0372446 A1
(43) Pub. Date: Nov. 7, 2024

(54) APPARATUS AND METHOD FOR MANUFACTURING LAMINATED CORE OF MOTOR

(71) Applicant: DAEYOUNG ELECTRIC CO., LTD., Gyeongsan-si (KR)

(72) Inventors: Seung Hyun BAEK, Daegu (KR); Byung Soo KWON, Gyeongsangbuk-do (KR)

(73) Assignee: DAEYOUNG ELECTRIC CO., LTD., Gyeongsan-si (KR)

(21) Appl. No.: 18/777,568

(22) Filed: Jul. 19, 2024

Related U.S. Application Data
(63) Continuation of application No. PCT/KR2022/020141, filed on Dec. 12, 2022.

(30) Foreign Application Priority Data
Jan. 20, 2022 (KR) 10-2022-0008231
Jan. 20, 2022 (KR) 10-2022-0008232
Jan. 20, 2022 (KR) 10-2022-0008233

(51) Int. Cl. H02K 15/02; H02K 15/12

(52) U.S. Cl. CPC H02K 15/02; H02K 15/12; H02K 2201/09; H02K 2215/00

(57) ABSTRACT

The apparatus for manufacturing a laminated core of a motor according to the present invention includes a laminating unit 1 for forming a base material 100 into a lamina member 201 by continuous press processing, and laminating a plurality of lamina members 201 to manufacture a laminated core 200; a pre-treatment unit 2 installed in the back of the laminating unit 1 to coat an activator on the front surface of the base material 100; and a discharge conveyor 10 installed at one side of the laminating unit 1 to transfer the laminated core 200 manufactured in the laminating unit 1, wherein the base material 100 has an adhesive coating layer 102 on the front surface and back surface of an electrical steel sheet 101.

### BACKGROUND OF THE INVENTION

### Technical Field

The present invention relates to an apparatus for manufacturing a laminated core of a motor. More specifically, the present invention relates to an apparatus for manufacturing a laminated core of a motor capable of increasing productivity and reducing manufacturing costs while improving the efficiency and quality of the laminated core.

### Background Art

In general, a stator or a rotor of a motor comprises a laminated core. The laminated core is manufactured by laminating a lamina member continuously formed from an electrical steel sheet by a press machine. The laminated lamina member needs to be combined with lamina members laminated therebelow and thereabove, and there are largely three ways of combining them.

Firstly, Korean Patent Laid-Open No. 10-2003-0054990 applies a manner of forming a plurality of embossings on a thin core sheet so that the embossing of an upper core sheet and the embossing of a lower core sheet are interlocked and coupled to each other. However, the motor core manufactured by coupling core sheets by the interlocking has a weak coupling force in a portion where the embossings are coupled. Additionally, the loss of flux density occurs due to the coupling portion, and thereby the efficiency is reduced when operating the motor.

Secondly, Korean Patent No. 10-1729282 discloses a manner of installing an adhesive coating device in a press mold, coating an adhesive on one surface of a core sheet while forming the core sheet, and laminating and heating core sheets so that an upper core sheet and a lower core sheet are coupled to each other by the adhesion of the adhesive. According to this manner, when the adhesion is lowered or the adhesive is insufficiently hardened, the core sheets may be separated. Also, a heater needs to be included in a press mold, and thus the apparatus may be complicated and manufacturing costs thereof may be increased.

Thirdly, Korean Patent No. 10-1811266 discloses a manner of coating a hardener while forming a core sheet in a press mold by using a self-bonding steel sheet in which an adhesive layer is coated on an electrical steel sheet, and laminating and heating core sheets, thereby adhering the core sheets with each other. According to this manner, it is difficult for the hardener to be uniformly coated in the mold. Additionally, the hardener simply lowers a hardening temperature, and the complete hardening of the adhesive coating layer can hardly be obtained. Thus, the laminated core needs to be heated again in the mold, and accordingly, the structure of the press machine becomes complicated, productivity becomes lowered, and manufacturing costs are increased.

Accordingly, the inventors of the present invention suggest an apparatus for manufacturing a laminated core of a motor which is advantageous for mass production by using an SB steel sheet but excluding the manner of coating a hardener in a die or heating a hardener in the die while laminating core sheets, thereby reducing manufacturing costs and improving the quality of a laminated core product.

### SUMMARY OF THE INVENTION

### Technical Problem

It is an object of the present invention to provide an apparatus for manufacturing a laminated core of a motor capable of reducing manufacturing costs while using an SB steel sheet.

It is another object of the present invention to provide an apparatus for manufacturing a laminated core of a motor capable of improving the quality of the laminated core.

It is yet another object of the present invention to provide an apparatus for manufacturing a laminated core of a motor capable of improving the productivity of the laminated core.

The objects above and other objects inferred therein can be easily achieved by the present invention explained below.

### Solution to Problem

An apparatus for manufacturing a laminated core of a motor according to the present invention comprises a laminating unit 1 for forming a base material 100 into a lamina member 201 by continuous press processing, and laminating a plurality of lamina members 201 to manufacture a laminated core 200; and a pre-treatment unit 2 installed in the back of the laminating unit 1 to coat an activator on the front surface of the base material 100, wherein the base material 100 has an adhesive coating layer 102 on the front surface and back surface of an electrical steel sheet 101.

According to the present invention, the apparatus may further comprise a post-processing unit 5 installed at one side of the laminating unit 1, wherein a supplementing unit 53, a measuring unit 54, a direct heating unit 55, an induction heating unit 56, and a cooling unit 57 may be sequentially installed on a process line 51 of the post-processing unit 5.

According to the present invention, the apparatus may further comprise a detection unit 6 installed at one side of the post-processing unit 5.

According to the present invention, the laminating unit 1 may comprise a lower die 11 comprising a plurality of piercing dies 111, a blanking die 112 installed in the front of the plurality of piercing dies 111, and a squeeze ring 13 installed in a lower portion of the blanking die 112; an upper die 12 comprising a piercing punch 121 installed above the piercing die 111, and a blanking punch 122 installed in the front of the piercing punch 121; and a laminated core 200 manufactured by continuously laminating, in the squeeze ring 13 installed in a lower portion of the blanking die 112, a lamina member 201 formed from the continuously supplied base material 100 by the piercing punch 121 and the blanking punch 122.

According to the present invention, the pre-treatment unit 2 may comprise a sprayer 21 installed in the back of the laminating unit 1 and in an upper portion of a main body 20 to coat an activator 150 on an upper portion of the base material 100.

According to the present invention, the laminating unit 1 may further comprise a back pressure mechanism 14 comprising a backing plate 141 for supporting a lower portion of the laminated core 200; an elevation drive means 142 for driving the backing plate 141 up and down; and an elevation rod 143 connected to a lower portion of the backing plate 141 and moving up and down by the elevation drive means 142.

According to the present invention, a load cell 141A may be installed in the backing plate 141.

According to the present invention, the sprayer 21 may comprise a nozzle rod 211 having a plurality of spraying holes 211A located in a horizontal straight line above the base material 100.

According to the present invention, the pre-treatment unit 2 may further comprise a thickness measurement device 22 installed in the back of the sprayer 21.

According to the present invention, preferably, when the base material 100 is transferred forward by a pitch, the sprayer 21 sprays the activator 150 to form a coated surface 100B on the front surface of the base material 100, but does not spray the activator 150 on a portion of the base material 100 for forming a lamina member 201 laminated on the top of the laminated core 200, to form a non-coated surface 100A.

A method for manufacturing a laminated core of a motor according to the present invention comprises providing a base material 100 having an adhesive coating layer 102 on the front surface and back surface of an electrical steel sheet 101; coating an activator on the front surface of the base material 100; and forming the base material 100 into a lamina member 201 and laminating a plurality of lamina members 201 to be a laminated core 200.

According to the present invention, preferably, whenever the base material 100 moves by a pitch, the activator is linearly sprayed to form a coated surface on the front surface of the base material 100.

According to the present invention, the method may further comprise heating the laminated core 200.

According to the present invention, the method may further comprise cooling the laminated core 200.

According to the present invention, the method may further comprise measuring the weight of the laminated core 200 and supplementing an additional sheet of lamina member 201 when the weight is insufficient compared to a predetermined weight.

### Advantageous Effects of Invention

The present invention is suitable for mass production while using an SB steel sheet, thereby reducing manufacturing costs, improving the quality of a laminated core product of a motor, and improving productivity.

### BRIEF DESCRIPTION OF DRAWINGS

FIG. 1 is a view illustrating a part of a base material used in an apparatus for manufacturing a laminated core of a motor according to the present invention;

FIG. 2 is a perspective view illustrating a laminated core manufactured by the apparatus for manufacturing a laminated core of a motor according to the present invention;

FIG. 3 is a plan view illustrating the entire layout of the apparatus for manufacturing a laminated core of a motor according to the present invention;

FIG. 4 is a conceptual diagram illustrating a laminating unit and a pre-treatment unit of the apparatus for manufacturing a laminated core of a motor according to the present invention;

FIG. 5 is a perspective view illustrating the operation of a sprayer of the pre-treatment unit in the apparatus for manufacturing a laminated core of a motor according to the present invention;

FIG. 6 is a conceptual diagram illustrating the base material coated with an activator in the pre-treatment unit in the apparatus for manufacturing a laminated core of a motor according to the present invention; and

FIG. 7 is a flow chart illustrating a method for manufacturing a laminated core of a motor according to the present invention.

Hereinafter, the present invention will be explained in detail with reference to the accompanying drawings.

### DETAILED DESCRIPTION OF THE INVENTION

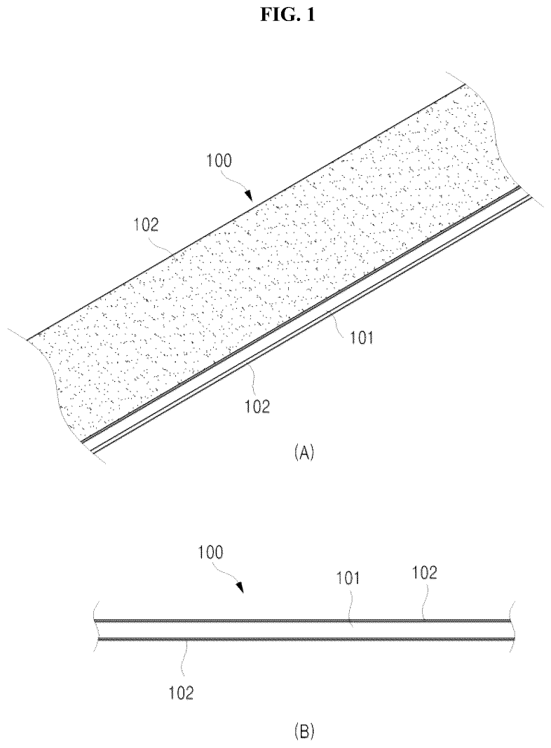

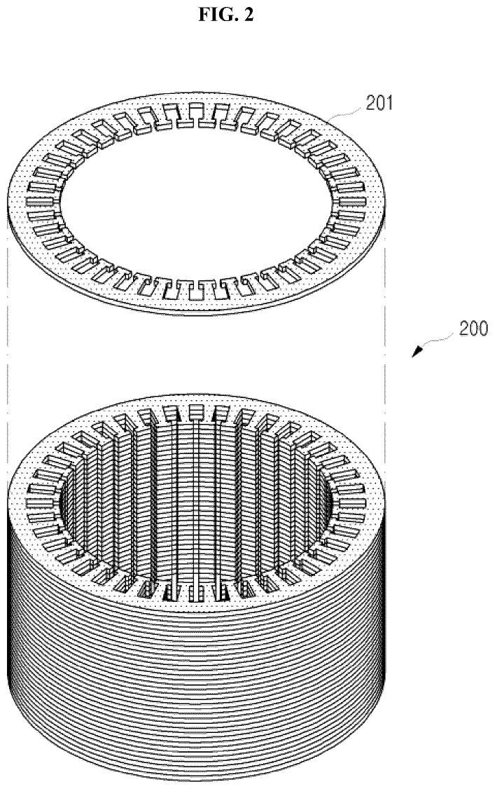

FIG. 1 is a view illustrating a part of a base material 100 used in an apparatus for manufacturing a laminated core of a motor according to the present invention, FIG. 1(A) is a perspective view of the base material 100, and FIG. 1(B) is a side view of the base material 100. FIG. 2 is a perspective view illustrating a laminated core 200 manufactured by the apparatus for manufacturing a laminated core of a motor according to the present invention.

As illustrated in FIGS. 1 and 2, the base material 100 used in the present invention, in which an adhesive coating layer 102 is formed on the front surface and back surface of an electrical steel sheet 101, is a so-called self-bonding steel sheet. The base material 100 of the present invention is continuously supplied to an apparatus for manufacturing a laminated core, and is sequentially formed in a laminating unit 1, which is a progressive press machine, to be formed into a lamina member 201 in the form of a sheet. The formed lamina members 201 are laminated to be a laminated core 200. FIG. 2 illustrates the shape of a rotor core for the laminated core 200 manufactured. However, the apparatus for manufacturing a laminated core according to the present invention may manufacture a stator core, not a rotor core.

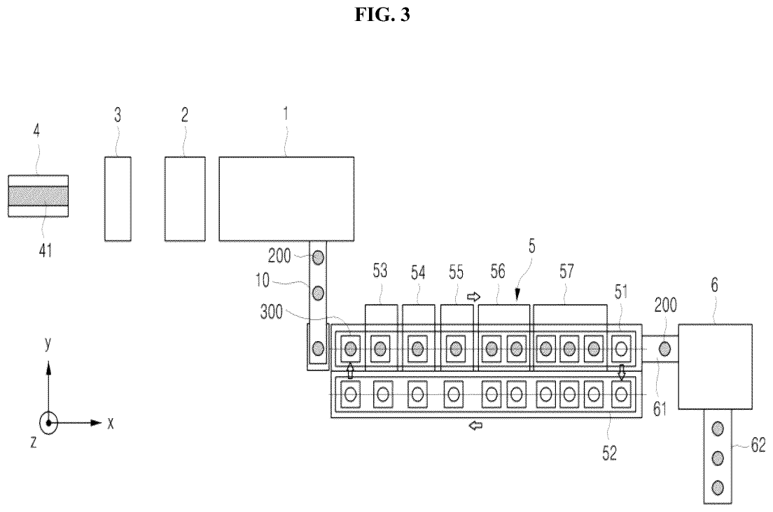

FIG. 3 is a plan view illustrating the entire layout of the apparatus for manufacturing a laminated core of a motor according to the present invention. As illustrated in FIG. 3, the apparatus for manufacturing a laminated core of a motor according to the present invention comprises a laminating unit 1, a pre-treatment unit 2, a welding unit 3, an uncoil unit 4, a post-processing unit 5, and a detection unit 6.

The laminating unit 1 forms the base material 100 which has passed through the pre-treatment unit 2 into a lamina member 201 by continuous press processing, and laminates a plurality of lamina members 201 to manufacture a laminated core 200. The pre-treatment unit 2 is a device which is installed in the back of the laminating unit 1 to perform operations such as coating an activator on the front surface of the base material 100, measuring the thickness, etc. As used herein, for reference, the terms “front” and “back” mean +x and −x directions, respectively, the terms “upper” and “lower” mean +z and −z directions, respectively, and the terms “left” and “right” mean +y and −y directions, respectively. Additionally, the term “one side” means any one direction in the xy plane.

The welding unit 3 is a device which connects, by the welding, the exhausted base material 100 supplied from a reel 41 with a base material 100 supplied from a next reel so that the base material 100 supplied from the uncoil unit 4 can be supplied continuously.

The uncoil unit 4 is a device which is installed in the back of the welding unit 3 to supply the base material 100. The base material 100 is installed in the uncoil unit 4 while wound around a reel 41. The base material 100 is supplied to the welding unit 3 as the reel 41 rotates. The welding unit 3 is a device which connects the exhausted base material 100 supplied from the reel 41 with a base material 100 supplied from a next reel 41. Thus, the base material 100 simply passes the welding unit 3 as long as the base material 100 is supplied continuously from a reel 41.

The base material 100 which has passed the welding unit 3 goes through the pre-treatment unit 2 and is processed in the form of laminated core 200 in the laminating unit 1. The detailed explanation on the laminating unit 1 and the pre-treatment unit 2 will be made again below.

The laminated core 200 manufactured by being laminated in the laminating unit 1 is placed on a discharge conveyor 10 installed at one side of the laminating unit 1. The laminated core 200 is transferred through the discharge conveyor 10 to one side of the post-processing unit 5 installed at one side of the discharge conveyor 10.

The post-processing unit 5 is a device for performing the collateral processing on the laminated core 200 in order to increase the product reliability of the laminated core 200 manufactured in the laminating unit 1, and comprises a process line 51, a return line 52, a supplementing unit 53, a measuring unit 54, a direct heating unit 55, an induction heating unit 56, and a cooling unit 57.

The process line 51 is a line in which each post-process is performed as a plurality of jigs 300 with laminated cores 200 mounted thereon are transferred in one direction. The return line 52 is a line which is installed at one side of the process line 51 to be parallel thereto, and in which an empty jig 300 is returned to the starting point of the process line 51 after the laminated core 200 is discharged from the jig 300. In other words, the jig 300 is installed to be continuously transferred on the process line 51 and return line 52.

A laminated core 200 is mounted on a jig 300 by a separate transfer mechanism (not illustrated) at the entrance of the process line 51. The jig 300 loaded with the laminated core 200 passes through the supplementing unit 53, the measuring unit 54, the direct heating unit 55, the induction heating unit 56, and the cooling unit 57, which are sequentially installed along the process line 51.

When the weight of the laminated core 200 manufactured in the laminating unit 1 is insufficient compared to the predetermined weight, the supplementing unit 53 additionally laminates the sheets of lamina member 201 on the laminated core 200. The weight of the laminated core 200 may be measured by a back pressure mechanism 14 of the laminating unit 1. Alternatively, if the weight is not measured by the back pressure mechanism 14, it may be measured when transferring the laminated core 200 to a jig 300 on the process line 51 from the discharge conveyor 10 using a transfer mechanism (not illustrated). In this case, a weight measurement means such as a load cell may be installed in the transfer mechanism.

The measuring unit 54 is installed at one side of the supplementing unit 53 to precisely measure the height of the laminated core 200. The laminated core 200 measured to have a height deviating from a predetermined range is determined as a defective product and is removed from the process line 51. A separate means or conveyor to remove a defective laminated core 200 may be further installed at one side of the measuring unit 54.

The direct heating unit 55 is installed at one side of the measuring unit 54 to heat the laminated core 200 in a direct heating manner using a heater. Since the laminated core 200 manufactured according to the present invention is laminated with an activator coated in the laminating unit 1, the adhesive coating layer coated on the front surface of the base material 100 is activated, thereby exerting sufficient adhesion. However, in order to secure much greater reliability of the product, the laminated core 200 may be heated in the direct heating unit 55. Additionally, the laminated core 200 heated in the direct heating unit 55 may be heated twice in a high-frequency induction heating manner in the induction heating unit 56 installed at one side of the direct heating unit 55.

The cooling unit 57 is a device which is installed at one side of the induction heating unit 56 to cool the heated laminated core 200, and may lower the temperature of the laminated core 200 in a blowing manner, a cold air spraying manner, etc.

The laminated core 200 which has finished the post-processing in the process line 51 is transferred to a loading part 61 of the detection unit 6 by a separate transfer mechanism (not illustrated), and the jig 300 loaded with the laminated core 200 is moved to the return line 52 by the conveyor, etc. to be returned to the starting point of the process line 51.

The detection unit 6 is installed at one side of the post-processing unit 5 to perform final detection on the size, weight, appearance, etc. of the product. The detection unit 6 comprises a loading part 61 and a shipping part 62. The loading part 61 allows laminated cores 200 to be transferred, and the shipping part 62 distinguishes good products passing detection from defective products for shipment.

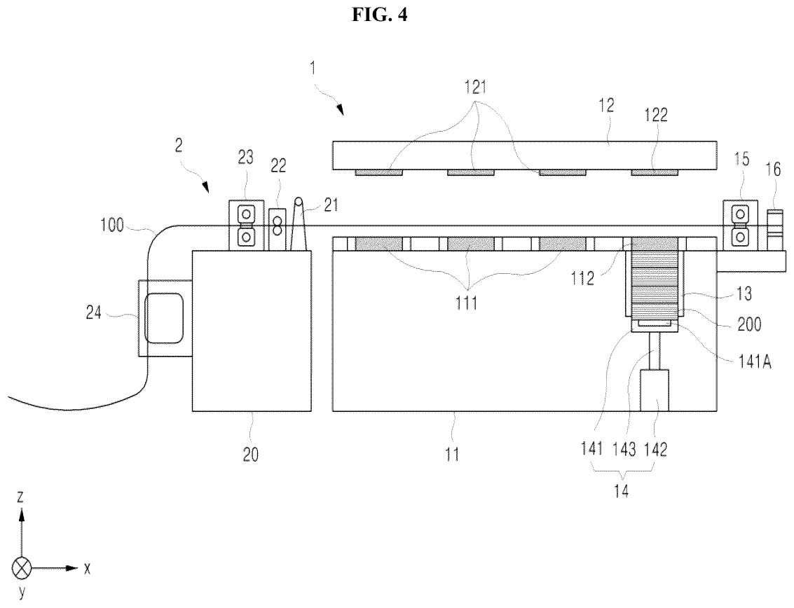

FIG. 4 is a conceptual diagram illustrating a laminating unit 1 and a pre-treatment unit 2 of the apparatus for manufacturing a laminated core of a motor according to the present invention. When referring to FIG. 4, the apparatus for manufacturing a laminated core of a motor according to the present invention comprises the laminating unit 1 which is a press machine enabling the continuous forming operation, and the pre-treatment unit 2 for pre-treating a supplied base material 100 before press forming. The base material 100 is supplied to the laminating unit 1 from the pre-treatment unit 2 installed in the back of the laminating unit 1.

The laminating unit 1 comprises a lower die 11 and an upper die 12. The upper die 12 is installed above the lower die 11 and moves up and down to press form the base material 100 continuously supplied.

In the lower die 11, a plurality of piercing dies 111 are sequentially installed, and a blanking die 112 is installed in the front of the last piercing die 111. In the upper die 12, a piercing punch 121 is installed above the piercing die 111 in a location corresponding thereto, and a blanking punch 122 is installed above the blanking die 112 corresponding thereto. FIG. 4 illustrates three pairs of the piercing dies 111 and the piercing punches 121, but three pairs or more or less may be used according to the shape of a laminated core.

The base material 100 is supplied to move at a pitch interval. The pitch means a distance between the centers of two adjacent piercing dies 111. The upper die 12, which has moved at a pitch interval and stopped, descends to form the base material 100. When the upper die 12 ascends, the base material 100 moves forward by a pitch. This operation is continuously repeated. The base material placed on the blanking die 112 is formed into a lamina member 201 by the blanking punch 122, and the lamina member 201 is separated from the base material 100. The lamina member 201 is laminated in a squeeze ring 13 installed in a lower portion of the blanking die 112 in the lower die 11. A plurality of lamina members 201 are laminated in the squeeze ring 13 to be a laminated core 200. The laminated core 200 is discharged from the squeeze ring 13 by a back pressure mechanism 14 installed in a lower portion of the squeeze ring 13 and moves to the lower portion, and then is discharged to the outside of the laminating unit 1.

The back pressure mechanism 14 comprises a backing plate 141 for supporting a lower portion of the laminated core 200, an elevation drive means 142 for operating the backing plate 141 up and down, and an elevation rod 143. The backing plate 141 supports a lower portion of the laminated core 200 when the laminated core 200 is discharged from the squeeze ring 13. The elevation rod 143 connected to the lower portion of the backing plate 141 moves up and down by the elevation drive means 142.

Accordingly, when the laminated core 200 placed on the backing plate 141 is discharged from the squeeze ring 13, the backing plate 141 moves downward, allowing the laminated core 200 to be moved to the discharge conveyor 10 installed at one side of the laminating unit 1 by a separate transfer means such as a transfer mechanism (not illustrated). For the elevation drive means 142, various means, such as motors, hydraulic cylinders, etc., which enables the elevation movement, can be used.

A load cell 141A may be installed in an upper surface of the backing plate 141. The load cell 141A is installed to measure the weight of the laminated core 200 placed on the backing plate 141. When the measured weight is lighter or heavier than a pre-stored weight of the laminated core 200, exceeding an error range, the laminated core can be handled as a defective product. Additionally, when the weight of the laminated core 200 is insufficient, lamina members 201 may be further laminated in order to supplement the insufficient weight after the laminated core is discharged to the outside of the laminating unit 1.

The pre-treatment unit 2 comprises a main body 20 installed at one side of the back of the lower die 11 of the laminating unit 1, a sprayer 21 installed in an upper portion of the main body 20, a thickness measurement device 22 installed in the back of the sprayer 21, a first feeder 23 installed in the back of the thickness measurement device 22, and a loop controller 24 installed in the back of the first feeder 23.

The sprayer 21 is a device which coats an activator on the front surface of the supplied base material 100. The activator is coated on the adhesive coating layer 102 coated on the front surface of the base material 100 to activate an adhesive reaction of the adhesive coating layer 102. Unlike conventional hardeners, the activator activates the adhesion of the adhesive coating layer 102 without simply lowering the hardening temperature of the adhesive coating layer 102. When the activator is coated on the adhesive coating layer 102 and then lamina members 201 are formed and laminated, the adhesive reaction is activated, thereby exhibiting adhesive performance without any additional heating. The activator is stored in a separate tank (not illustrated) installed inside the main body 20 and supplied.

The thickness measurement device 22 measures the thickness of the supplied base material 100, allowing correction of the height of laminated core products or distinguishing of defective products later. The thickness measurement device 22 may comprise various thickness measurement means such as a laser sensor, etc., to measure the thickness of the base material 100.

The first feeder 23 pushes the base material 100 so that the base material 100 can be continuously supplied by a pitch. A second feeder 15 is installed in the front of the laminating unit 1, and the second feeder 15 pulls the base material 100 so that the base material 100 can be continuously supplied by a pitch. The base material 100 which has passed through the second feeder 15 is cut by a scrap cutter 16 installed in the front of the second feeder 15 and discharged to the outside of the laminating unit 1 by a separate scrap collecting mechanism (not illustrated).

The loop controller 24 is a device which adjusts the deflection of the base material 100 so that the base material 100 can be supplied to the first feeder 23 with a constant amount when passing the welding unit 3 supplied from the uncoil unit 4. When the amount of the base material supplied to the first feeder 23 is not constant, the continuous press operation cannot be done smoothly.

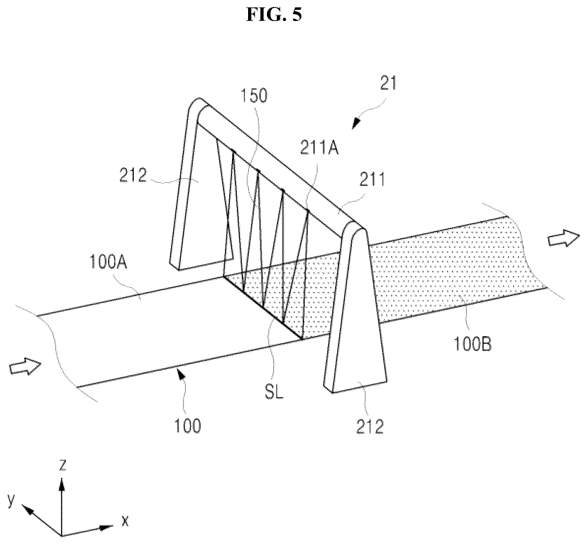

FIG. 5 is a perspective view illustrating the operation of a sprayer 21 of the pre-treatment unit 2 in the apparatus for manufacturing a laminated core of a motor according to the present invention. The sprayer 21 of the present invention is a device for coating an activator 150 on the front surface of the base material 100 as explained above. The sprayer 21 comprises a nozzle rod 211 for coating the activator 150 above the base material 100, and a nozzle stand 212 installed in the upper portion of the main body 20 allowing the nozzle rod 211 to be located above the base material 100. The nozzle rod 211 has a plurality of spraying holes 211A for spraying the activator 150.

The spraying holes 211A are located in a straight line in the left and right direction to spray the activator along a spraying line SL. The spraying line SL is formed left and right in an upper surface of the base material 100 progressing forward. In other words, the activator 150 is coated on the spraying line SL, and thus is linearly sprayed. As the base material 100 moves forward while the activator 150 is coated on the spraying line SL, a non-coated surface 100A, which is the front surface of the base material 100 before passing through the spraying line SL, is turned into a coated surface 100B coated with the activator after passing through the spraying line SL.

Accordingly, even though the activator 150 is sprayed linearly on the spraying line SL, the activator 150 is coated on the front surface of the base material 100 in a plane form, to obtain the coated surface 100B. Therefore, the base material 100 in which the activator 150 is uniformly coated on the coated surface 100B can be obtained. When the circular or planar coating is performed when the activator 150 is sprayed from the spraying hole 211A, the activator overlap in some portions, and thus uniform coating can hardly be obtained.

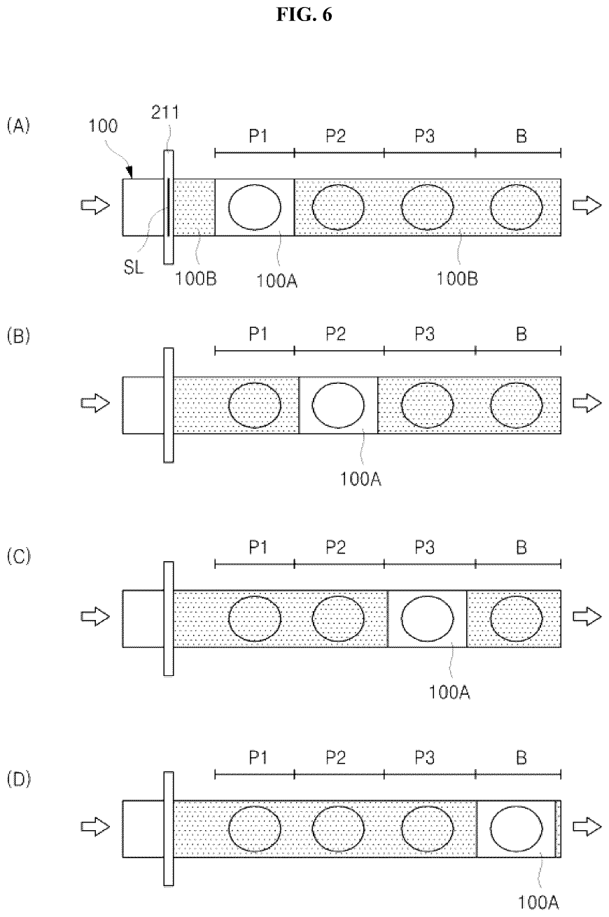

FIG. 6 is a conceptual diagram illustrating the base material 100 coated with an activator 150 in the pre-treatment unit 2 in the apparatus for manufacturing a laminated core of a motor according to the present invention. FIG. 6 is a top plan view of the base material 100 passing through a nozzle rod 211 of the sprayer 21 each pitch. When a laminated core 200 is laminated in the squeeze ring 13, it should be separated from a laminated core 200 laminated thereabove, not being adhered thereto. Accordingly, the activator 150 should not be coated on the lamina member 201 laminated on the top of the laminated core 200. This is shown in FIG. 6 step by step.

For example, if we assume that 20 lamina members 201 are laminated to be a laminated core 200, the base material 100 passes through the spraying line SL below the nozzle rod 211 to form a coated surface 100B coated with the activator. The activator is coated to the 19th lamina member to form the coated surface 100B. As illustrated in FIG. 6(A), when the last 20th lamina member passes through the spraying line SL, a non-coated surface 100A with no activator coated thereon is formed.

Therefore, the non-coated surface 100A sequentially passes through piercing processes P1, P2, and P3 as illustrated in FIGS. 6(A), (B), and (C), and the lamina member 201 is separated from the base material 100 and is laminated in the squeeze ring 13 by the blanking process B in FIG. 6(D). In the lamina member 201 laminated on the top of the laminated core 200, the adhesive coating layer 102 is not activated due to the non-coated surface 100A, and thus the laminated core 200 and a laminated core 200 laminated thereabove are not adhered to each other, but are separated from each other.

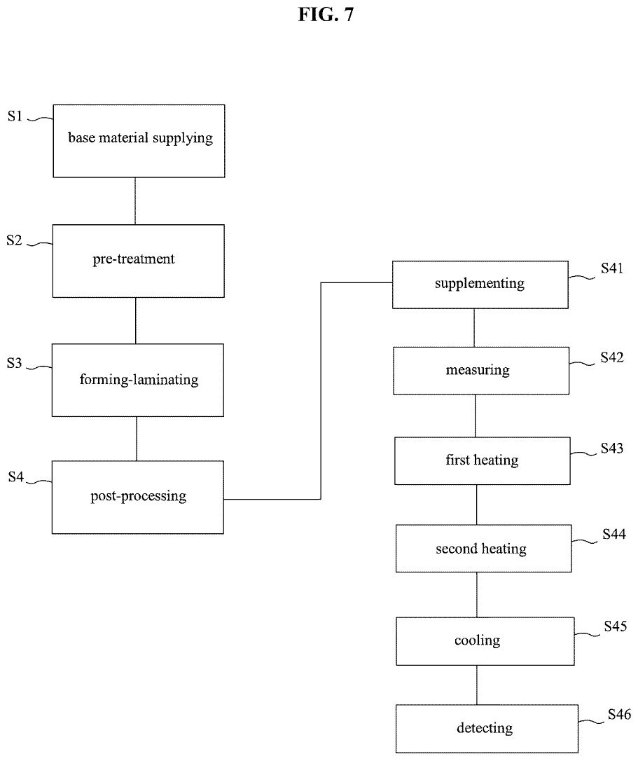

FIG. 7 is a flow chart illustrating a method for manufacturing a laminated core of a motor according to the present invention. As illustrated in FIG. 7, the method for manufacturing a laminated core of a motor according to the present invention comprises a base material supplying step S1, a pre-treatment step S2, a forming-laminating step S3, and a post-processing step S4.

In the base material supplying step S1, a base material 100 having an adhesive coating layer 102 formed on the front surface and back surface of an electrical steel sheet 101 is prepared and supplied to a pre-treatment unit 2.

In the pre-treatment step S2, an activator is coated on the front surface of the base material 100. Whenever the base material 100 moves by a pitch, the activator 150 is linearly sprayed on a spraying line SL to form a coated surface 100B in the front surface of the base material 100.

In the forming-laminating step S3, the base material 100 is formed into a lamina member 201, and a plurality of formed lamina members 201 are laminated to manufacture a laminated core 200.

The manufactured laminated core 200 goes through the post-processing step S4. The post-processing process S4 comprises a sheet supplementing step S41, a height measuring step S42, a first heating step S43, a second heating step S44, a cooling step S45, and a detecting step S46.

In the supplementing step S41, when the weight of the manufactured laminated core 200 is insufficient compared to the predetermined weight, an additional sheet of lamina member 201 is further laminated on the laminated core 200.

In the measuring step S42, when the height of the laminated core 200 is precisely measured and the height deviates from a predetermined range, the laminated core 200 is determined as a defective product and is separately discharged.

In the first heating step S43, the laminated core 200 is directly heated by a heater, etc. In the second heating step S44, the laminated core 200 is heated by the induction heating using a high-frequency induction heater. Any one step of the first heating step S43 or the second heating step S44 may be omitted according to need for processes, etc.

In the cooling step S45, the heated laminated core 200 is cooled. In the detecting step S46, the manufactured laminated core 200 is detected to distinguish good products from defective products for shipment.

The detailed description of the present invention described as above simply explains examples for understanding the present invention, but does not intend to limit the scope of the present invention. The scope of the present invention is defined by the accompanying claims. Additionally, it should be construed that simple modifications or changes of the present invention fall within the scope of the present invention.

What is claimed is:

1. An apparatus for manufacturing a laminated core of a motor, comprising:
a laminating unit 1 for forming a base material 100 into a lamina member 201 by continuous press processing, and laminating a plurality of lamina members 201 to manufacture a laminated core 200; and
a pre-treatment unit 2 installed in the back of the laminating unit 1 to coat an activator on the front surface of the base material 100,
wherein the base material 100 has an adhesive coating layer 102 on the front surface and back surface of an electrical steel sheet 101.

2. The apparatus of claim 1, further comprising:
a post-processing unit 5 installed at one side of the laminating unit 1,
wherein a supplementing unit 53, a measuring unit 54, a direct heating unit 55, an induction heating unit 56, and a cooling unit 57 are sequentially installed on a process line 51 of the post-processing unit 5.

3. The apparatus of claim 2, further comprising:
a detection unit 6 installed at one side of the post-processing unit 5.

4. The apparatus of claim 1, wherein the laminating unit 1 comprises:
a lower die 11 comprising a plurality of piercing dies 111, a blanking die 112 installed in the front of the plurality of piercing dies 111, and a squeeze ring 13 installed in a lower portion of the blanking die 112;
an upper die 12 comprising a piercing punch 121 installed above the piercing die 111, and a blanking punch 122 installed in the front of the piercing punch 121; and
a laminated core 200 manufactured by continuously laminating, in the squeeze ring 13 installed in a lower portion of the blanking die 112, a lamina member 201 formed from the continuously supplied base material 100 by the piercing punch 121 and the blanking punch 122.

5. The apparatus of claim 1, wherein the pre-treatment unit 2 comprises a sprayer 21 installed in the back of the laminating unit 1 and in an upper portion of a main body 20 to coat an activator 150 on an upper portion of the base material 100.

6. The apparatus of claim 4, wherein the laminating unit 1 further comprises a back pressure mechanism 14 comprising:
a backing plate 141 for supporting a lower portion of the laminated core 200;
an elevation drive means 142 for driving the backing plate 141 up and down; and
an elevation rod 143 connected to a lower portion of the backing plate 141 and moving up and down by the elevation drive means 142.

7. The apparatus of claim 6, wherein a load cell 141A is installed in the backing plate 141.

8. The apparatus of claim 5, wherein the sprayer 21 comprises a nozzle rod 211 having a plurality of spraying holes 211A located in a horizontal straight line above the base material 100.

9. The apparatus of claim 4, wherein the pre-treatment unit 2 further comprises a thickness measurement device 22 installed in the back of the sprayer 21.

10. The apparatus of claim 5, wherein when the base material 100 is transferred forward by a pitch, the sprayer 21 sprays the activator 150 to form a coated surface 100B on the front surface of the base material 100, but does not spray the activator 150 on a portion of the base material 100 for forming a lamina member 201 laminated on the top of the laminated core 200, to form a non-coated surface 100A.

11. A method for manufacturing a laminated core of a motor, comprising:
providing a base material 100 having an adhesive coating layer 102 on the front surface and back surface of an electrical steel sheet 101;
coating an activator on the front surface of the base material 100; and
forming the base material 100 into a lamina member 201 and laminating a plurality of lamina members 201 to be a laminated core 200.

12. The method of claim 11, wherein whenever the base material 100 moves by a pitch, the activator is linearly sprayed to form a coated surface on the front surface of the base material 100.

13. The method of claim 11, further comprising:
heating the laminated core 200.

14. The method of claim 13, further comprising:
cooling the laminated core 200.

15. The method of claim 11, further comprising:
measuring the weight of the laminated core 200 and supplementing an additional sheet of lamina member 201 when the weight is insufficient compared to a predetermined weight.
